(19) United States
(12) Patent Application Publication
(10) Pub. No.: US 2010/0097008 A1
(43) Pub. Date: Apr. 22, 2010

(54) Power Control Circuit of Photo Coupler

(76) Inventor: Ta-Cheng Hsiung, Chung-Ho City (TW)

Correspondence Address: Yen Jung Sung, 21-80 38 St, #C8, Astoria, NY, 11105, US

(21) Appl. No.: 12/473,276

(22) Filed: May 28, 2009

(30) Foreign Application Priority Data
Oct. 20, 2008 (TW) 097218727

(51) Int. Cl. H05B 37/02

(52) U.S. Cl. 315/293

(57) ABSTRACT

A power control circuit of photo coupler mainly includes a plurality of impedances having one end connected in parallel with a pin of a photo coupler and the other end connected with a relative control pin of an integrated circuit, in which the values of the plural impedances are chosen in a class-by-class pattern on a basis of impedance value to increase or decrease a total impedance value class by class in a range by varying a high impedance or low output via the relative control pin of the IC. As such, the combined circuit is simplified and practical and achieves an effect taking cost and precise adjustment into account to possess digital adjustment of impedance range without spending a lot.

### FIELD OF THE INVENTION

The present invention relates to a power control circuit of optical coupler, which has a simplified and practical structural design and employs a plurality of selected impedances in collaboration with the corresponding IC control pins so that the combined circuit can achieve the effect that possesses digital adjustment of impedance range and makes cost and accurate adjustment meet without spending a lot.

### BACKGROUND OF THE INVENTION

An input end of a photo coupler is an infrared light-emitting diode (LED), and a receiving end is a photo transistor. While supplying power to turn on the LED and make it illuminate and irradiate light to the photo transistor, the photo transistor will turn on accordingly. Hence, it is possible for the photo coupler to transfer signal under a condition of total electrical isolation and to be applied to the signal transmission of a low-voltage circuit and a high-voltage circuit or to be adopted in a place with high noise to avoid malfunction arising from noise by using electrical isolation to prevent noise generated from a circuit from being transmitted to another circuit.

The transmission power control to an optocoupler in regular circuit is either by voltage or impedance control. The so-called voltage control simply changes the voltage value of the input end VCC1 in FIG. 1. Because the impedance value of a load Zᵢ is constant, the current Iᵢ is linearly adjusted according to the voltage value of VCC1. The other way around, if the voltage VCC1 of the input end remains constant, varying the impedance value of a load Zᵢ in FIG. 1 can similarly control the magnitude of the current Iᵢ.

As to the dynamic range of the voltage of the receiving end V_{o,}, adjusting the impedance of load Z_{L} can change the dynamic range of Vₒ to upgrade the recognition of post-end circuit.

So far, although the more advanced control circuit of conventional optocoupler can employ a potentiometer to precisely adjust the values of the input and output loads Zᵢ and Z_{L}, the combined circuit must spend relatively higher cost from which its major shortcoming comes.

### SUMMARY OF THE INVENTION

In view of the foregoing concern, the creator of the present invention endeavors to develop and make improvement to provide a power control circuit of photo coupler having a simplified and practical structural design and using a plurality of selected impedances in collaboration with control pins of a corresponding IC so that the combined circuit can possess a digital impedance-adjusting range without spending a lot to achieve an effect of taking both cost and precise adjustment into account.

To achieve the aforementioned objective, a power control circuit of photo coupler in accordance with the present invention mainly includes: a plurality of impedances having one end connected in parallel with a pin of a photo coupler and the other end connected with a relative control pin of an integrated circuit (IC), and disposed in a class-by-class pattern on a basis of impedance value to increase or decrease a total impedance value class by class in a range by varying a high impedance or low output via the relative control pin of the IC;

whereby a circuit in combination with the power control circuit of photo coupler is simplified and practical and achieves a effect taking cost and precise adjustment into account.

The foregoing and other features and advantages of the present invention will be more clearly understood through the following descriptions with reference to the drawing, wherein:

### BRIEF DESCRIPTION OF THE DRAWINGS

FIG. 1 is a circuit diagram of a conventional power control structure of optocoupler;

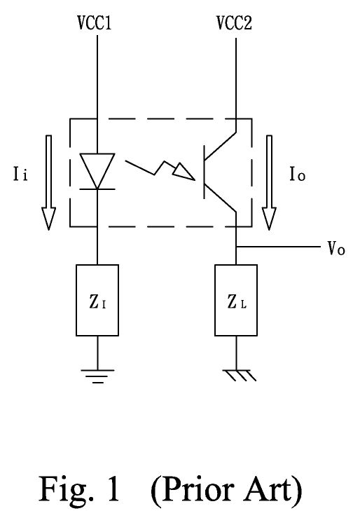

FIG. 2 is a circuit diagram showing an input end of a photo coupler in accordance with the present invention;

FIG. 3 is a circuit diagram showing a preferred embodiment in accordance with the present invention;

FIG. 4 is a circuit diagram showing a receiving end of the photo coupler in accordance with the present invention; and

FIG. 5 is a circuit diagram showing two sides of the photo coupler in accordance with the present invention.

### DETAILED DESCRIPTION OF THE PREFERRED EMBODIMENT

It is to be noted that the following descriptions of preferred embodiments of this invention are presented herein for purpose of illustration and description only; it is not intended to be exhaustive or to be limited to the precise form disclosed.

The present invention will now be described more specifically with reference to the following embodiments.

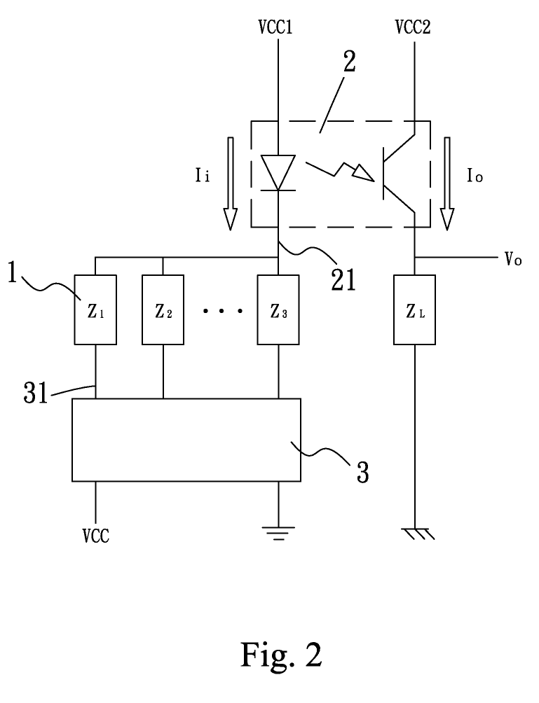

With reference to FIG. 2˜5, a power control circuit of photo coupler of the present invention mainly includes:

a plurality of impedances 1 with one end connected in parallel with a pin 21 of a photo coupler 2 and the other end connected with a relative control pin 31 of an integrated circuit IC3, in which the values of the plural impedances 1 are chosen based on the magnitude class and the total impedance value of the plural impedances 1 increase or decrease in a certain range in a class-by-class pattern by varying high impedance or low output of the relative control pin 31 of the integrated circuit IC3.

With reference to FIG. 2, which illustrates a preferred embodiment of the present invention, if there are n impedances 1 in the circuit, they can be categorized into 2ⁿ classes and the impedance values of the n impedances 1 can be expressed by the following formula:

Zₙ=Z₁×F⁽ⁿ⁻¹⁾

where F is a real number greater than 0.

IC3, which can be a digital IC, makes its relative control pin 31 generate a 0 and 1 output variation so as to possess a precise adjustment range with 2ⁿ classes.

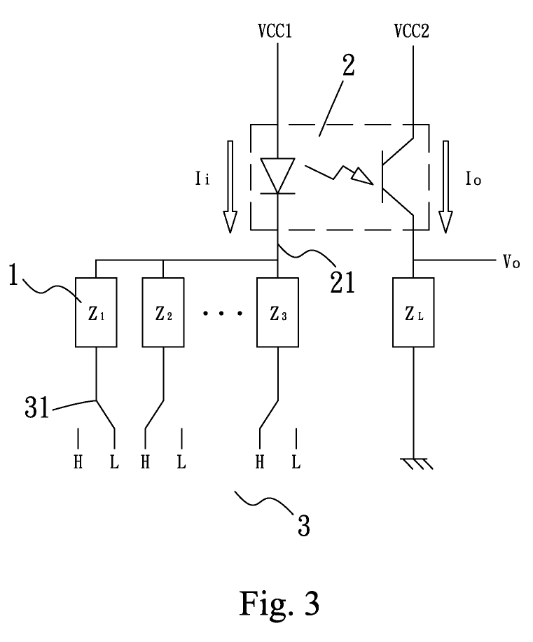

Therefore, with reference to FIG. 2 and FIG. 3, adopting the structural model of the present invention can make the combined circuit simplified and practical. Despite no costly potentiometer employed in the circuit, the circuit can still generate 2ⁿ classes of adjustment ranges by the output variation of 0 and high impedance generated by the relative control pin 31 in collaboration with the corresponding n impedances 1. In consideration of the cost at the same time, a precise adjustment effect approximate to the potentiometer can be achieved.

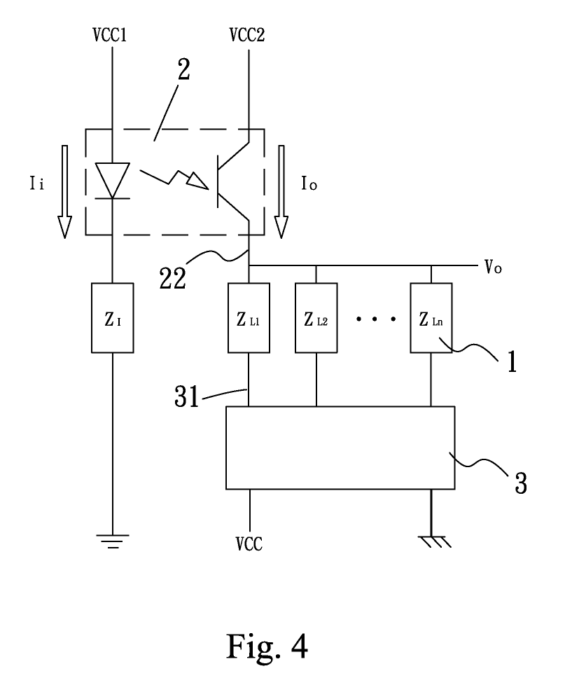

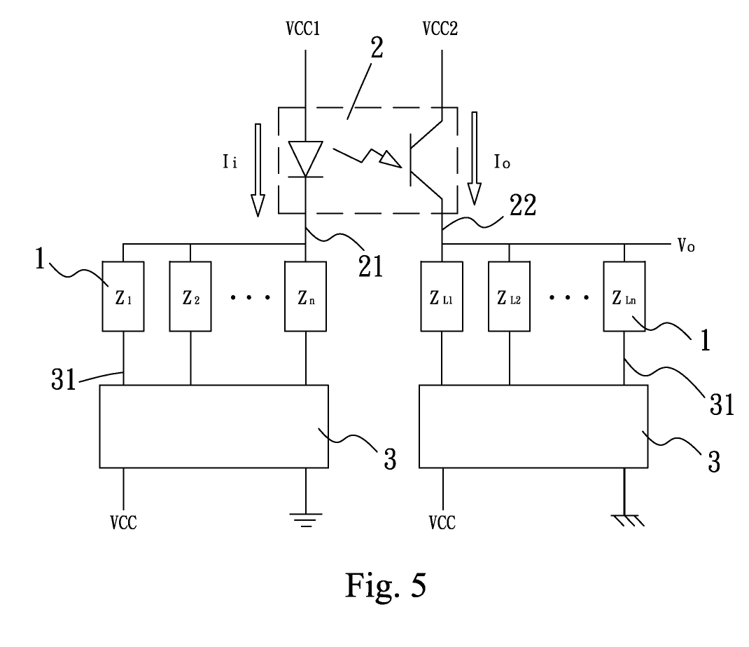

Upon implementing, the present invention can be provided in accordance with different application requirement of actual demand. For example, as shown in FIG. 2, the plural impedances 1 are located underneath the N-junction pin 21 of an LED at the input end of the photo coupler 2 and individually connected in parallel therewith; or as shown in FIG. 4, the plural impedances 1 are located underneath the emitter pin 22 of an LED at the receiving end of the photo coupler 2 and individually connected in parallel therewith; or as shown in FIG. 5, a power control circuit in accordance with the present invention is disposed underneath a pin 21 at the input end and a pin 22 at the receiving end of the photo coupler 2 respectively, such that the impedance values on both sides can be precisely increased and decreased in a class-by-class pattern.

Furthermore, practically, the plural impedances 1 can be a resistor as well because resistor is inexpensive and easily acquired. However, as the standard resistor values out of mass production may not be exactly the values specified in the specifications, special attention should be paid thereto. If the accuracy requirement is not very demanding, an error in each class is permissible. Whereas, the absolute value of the error value of the impedances 1 in each class shall be less than half of the primary (resistor) impedance Z₁. As such, the divisions of the total impedance 1 can be divided into 2ⁿ classes except that a geometric relationship does not exist in all classes. Anyhow, a rather superior class-by-class adjustment can still be maintained to attain the effect of changing the impedance value.

In sum, the present invention provides the practical and innovative value to the industry and the application is hereby submitted in accordance with the patent laws.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A power control circuit for a photo coupler comprising:
a plurality of impedances having one end connected in parallel with a pin of a photo coupler and the other end connected with a relative control pin of an integrated circuit (IC), and disposed in a class-by-class pattern on a basis of impedance value to increase or decrease a total impedance value class by class in a range by varying a high impedance or low output via the relative control pin of the IC.

2. The power control circuit for a photo coupler as claimed in claim 1, wherein the photo control circuit for a photo coupler has n impedances to be categorized into 2ⁿ classes, and the relative control pin of the IC has 2ⁿ classes of adjustment ranges.

3. The power control circuit for a photo coupler as claimed in claim 2, wherein the IC is a digital integrated circuit and the control pin varies to generate a 0 or a high-impedance output.

4. The power control circuit for a photo coupler as claimed in claim 2, wherein a formula of impedance value is expressed by Zₙ=Z₁×F⁽ⁿ⁻¹⁾ and F is a real number greater than 0.

5. The power control circuit for a photo coupler as claimed in claim 2, wherein the impedance values of all classes do not pertain to a geometric relationship, and an absolute value of the error value in each class is less than half of a primary impedance Z₁.

6. The power control circuit for a photo coupler as claimed in claim 3, wherein the impedances are a resistor and are connected in parallel with an N-junction pin of an LED at an input end of the photo coupler.

7. The power control circuit for a photo coupler as claimed in claim 4, wherein the impedances are a resistor and are connected in parallel with an N-junction pin of an LED at an input end of the photo coupler.

8. The power control circuit for a photo coupler as claimed in claim 5 wherein the impedances are a resistor and are connected in parallel with an N-junction pin of an LED at an input end of the photo coupler

9. The power control circuit for a photo coupler as claimed in claim 3, wherein the impedances are a resistor and are connected in parallel with an emitter pin of an LED at a receiving end of the photo coupler.

10. The power control circuit for a photo coupler as claimed in claim 4, wherein the impedances are a resistor and are connected in parallel with an emitter pin of an LED at a receiving end of the photo coupler.

11. The power control circuit for a photo coupler as claimed in claim 5, wherein the impedances are a resistor and are connected in parallel with an emitter pin of an LED at a receiving end of the photo coupler.
